(19) United States
(12) Patent Application Publication
(10) Pub. No.: US 2021/0012021 A1
(43) Pub. Date: Jan. 14, 2021

(54) INTERPOSED SECURE FUNCTION CALLS

(71) Applicant: Jeff Pickhardt, Palo Alto, CA (US)

(72) Inventor: Jeff Pickhardt, Palo Alto, CA (US)

(21) Appl. No.: 16/802,934

(22) Filed: Feb. 27, 2020

Related U.S. Application Data
(60) Provisional application No. 62/873,800, filed on Jul. 12, 2019.

(51) Int. Cl. G06F 21/62; H04L 29/06; H04L 29/08; H04L 12/24; G06F 9/54

(52) U.S. Cl. CPC G06F 21/629; H04L 69/22; H04L 63/0428; H04L 63/0236; H04L 41/0266; G06F 9/547; H04L 67/02

(57) ABSTRACT

Methods, systems, and apparatus, including computer programs encoded on computer storage media for Interposed Secure Function Calls. One of the operations is performed by interposing a first application function with a second application function. The second application function executes when the first application function is called by another process or other code. The process or other code makes a function call to the first application function, but instead of executing the first application function, the interposed second application function is executed. The function call includes an argument payload which is evaluated for safety and security. If the function call and/or argument payload is determined to be safe, the interposed second application function will perform the first application function using the argument payload. Otherwise, the first application function is not performed.

### CROSS-REFERENCE TO RELATED APPLICATION

This application claims the benefit of U.S. Provisional Patent Application No. 62/873,800 filed on Jul. 12, 2019 and entitled “INTERPOSED SECURE FUNCTION CALLS,” which application is hereby incorporated by reference in its entirety.

### BACKGROUND

Various security threats affect the use of web browsers and web applications. To address some security threats, web application servers may use certain security products, such as web application firewalls. A web application firewall may protect a web application server from malicious requests such as SQL injection or buffer overflow attempts. However, the web application firewall does not protect the client-side web application against malicious code running in a user's web browser. For example, vulnerabilities may exist in a client-side web application where an attacker can inject JavaScript into the client-side web application and obtain sensitive data, such as passwords, credit cards and other information, and transfer the sensitive data to a third party server via a network transfer request. A need exists to identify security threats and secure web browsers against client-side threats.

### SUMMARY

Described herein is an exemplary system for interposed secure function calls. The system redefines a standard application function to call another specific newly defined function (i.e., the interposed secured function). When the original standard application function is called, the newly defined function is executed. The newly defined function performs some security or safety checks or other actions, such as analyzing passed arguments in the original called function. The checks are used to ensure security and safety of performing the standard application function. If the system determines that the original called function would have been safe to be performed, then the interposed secured function will call the original function with the original arguments. If the system determines that the original called function would not have been safe to be performed, then the interposed secured function call would not perform the original function with the original arguments, but instead take some other action.

In general, one innovative aspect of the subject described in this specification can be embodied in systems, computer readable media, and methods that include operations for interposed secure function calls. One of the operations is performed by interposing a first application function with a second application function. The second application function executes when the first application function is called by another process or code. The process or code makes a function call to the first application function, but instead of executing the first application function, the interposed second application function is executed. The function call includes an argument payload which is evaluated for safety and security. If the function call and/or argument payload is determined to be safe, the interposed second application function will perform the first application function using the argument payload.

Another innovative aspect of the subject described in this specification can be embodied in systems, computer readable media, and methods that include operations for interposed secure function calls. One of the operations is performed by interposing a first application function with a second application function. The second application function executes when the first application function is called by another process or code. The process or code makes a function call to the first application function, but instead of executing the first application function, the interposed second application function is executed. The system may track events and information about instances when the first application function is called. The second application function transmits data to a server about function calls to the first application function. Examples of event data that may be captured and transmitted include, but is not limited to, one or more of the following information: the date/time of the function call, size and contents of the argument payload, name of the process or other code making the first application function call, the number of arguments of the first application function call, a customer identifier, or a web page identifier.

### BRIEF DESCRIPTION OF THE DRAWINGS

The present disclosure will become better understood from the detailed description and the drawings, wherein:

FIG. 1 illustrates an example system architecture for interposed secure function calls.

FIG. 2 illustrates a flowchart of an example process for interposed secure function calls.

FIG. 3 illustrates a non-transitory computer media including instructions for interposed secured function calls.

FIG. 4 illustrates a flowchart of an example process for interposed secure function calls for a web page and browser.

FIG. 5 illustrates example code for interposing functions of an application.

FIG. 6 illustrates example code for interposing functions of an application.

FIG. 7 illustrates example code for interposing functions of an application.

FIG. 8 illustrates an example machine of the computer system.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

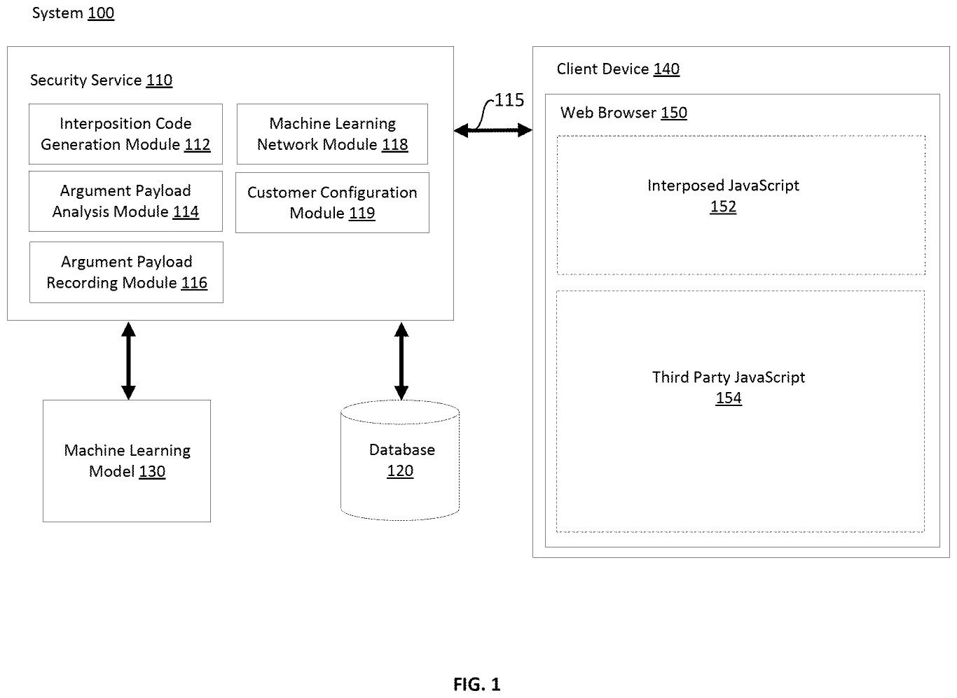

FIG. 1 illustrates an example system architecture for interposed secure function calls. The system 100 includes a Security Service 110 and one or more client devices 140, a machine learning model 130 and a database 120. The Security Service 110 includes an Interposition Code Generation Module 112, Argument Payload Analysis Module 114, Argument Payload Recording Module 116, Machine Learning Module 118 and Customer Configuration Module 119.

The client device 140 communicates, via communications network 115, with the Security Service 110. The client device 140 employs a web browser 150 for interaction with web sites. The web browser 150 executes interposed secured interposed functions 152 (e.g., interposed JavaScript functions). The secured interposed functions 152 interact with other code or processes 154 operating within or by the web browser 150, such as third-party JavaScript code or plug-ins to the web browser.

The Interposition Code Generation Module 112 serves interposition code to the web browser 150. A request may be made by the web browser 150 to the Security Service 110 to receive interposition code. The Interposition Code Generation Module 112 may customize the interposition code as to a particular customer based on a customer's unique identifier. The interposition code may redefine a set of functions specific to a customer's application. The particular functions that are to be redefined are stored in the database 120 and retrieved based on the customer's unique identifier. The database 120 may be a local or remote database or other type of storage cache.

The Argument Payload Analysis Module 114 analyzes or evaluates argument payloads. The web browser 150 via the interposition code 152 sends to the Security Service 110 information about function calls (e.g., the type of function and argument payload) to be evaluated for safety or security. An argument payload includes some or all of the arguments or data that is passed in a function call, where the called function has been redefined in the interposition code 152. The Argument Payload Analysis Module 114 may perform various security checks on the argument payload as described herein. The Argument Payload Analysis Module 114 returns an indication to the interposition code 152 of whether or not the function call is safe or secure to be performed. While the Security Service 110 may perform the security checks, the interposition code 152 on the web browser 150 may also perform security checks.

In additional to analyzing the argument payload, the Argument Payload Analysis Module 114 may remove from the original argument payload one or more suspicious arguments, data, code, and/or sensitive data thereby creating a safe argument payload. The safe argument payload without the suspicious elements is then transmitted back to the web browser. The interposition code may then perform the original function call with the safe argument payload. For example, IP address or credit card information may be removed from the original argument payload. By removing unsafe or suspicions elements in the original argument payload, the system 100 may allow the web browser and web application to perform the original function call with the safe argument payload.

The Argument Payload Recording Module 116 records metadata or information to the database 120 about function calls and argument payloads received by the Security Service 110. Some of this information includes the type of function, and the content of the argument payload. Additionally, the Argument Payload Analysis Module 114 may update the record as to whether the function was determined to be unsafe or not secure, and the possible type of security threat.

The Argument Payload Recording Module 116 may also track events about function calls. For example, an interposed function may send information to the Security Service 110 about an interposed function. Interposition code may send information for event tracking about interposed function calls, such as the date/time of the original function call, the argument payload, name of the process or other code making the original function call, the number of arguments of the original function call, the size of the argument payload, a customer identifier and a web page identifier. The Security Service 110 may then use this information to determine patterns of suspicious activities by an event type. Additionally, the Machine Learning Module 118, discussed below, may learn that certain events are unsafe to be performed, and identify the type of event as unsafe or insecure.

The Machine Learning Module 118 interacts with the Machine Learning Model 130. The system 100 may use Machine Learning Model 118 to determine unsafe or insecure actions of a function call. The Machine Learning Model 130 may be trained to recognize different types of security threats based on samples of argument payload data. One or more machine learning models (e.g., a neural network or Naive Bayes classifier) may be trained on various criteria such as: the type of function call; the size of the argument payload; entropy of bits of the payload (e.g., encrypted or compressed); suspicious Unicode characters; obscure or unusual Hypertext Markup Language (HTML) tags; overly long parameters to the function; unusual methods of doing things (e.g., making network request in unusual ways); and/or whether the code appears polymorphic (e.g., code which is received encoded, and decodes itself to run).

The Argument Payload Analysis Module 114 provides the argument payload data to the Machine Learning Model 118. The Machine Learning Module 114 then determines using the Machine Learning Model 118 the probability or likelihood that the argument payload is of a certain type of security threat. The Machine Learning Module 118 then sends an indication of the type of possible threat or that no threat has been detected to the Argument Payload Analysis Module 114.

The machine learning models may run on servers to detect whether potential malware occurred on a web page. Moreover, the security enforcement processing may run on the client-side to detect and prevent attacks. Additionally, there may a combination of security enforcement processing where the client-side web page detects something suspicious and sends data back to the Security Service 110 and the client-side web delays execution of a function call made by code running on the web browser. Then if the Security Service 110 identifies likely malware, then the client-side web page prevents or mitigates the attack, or otherwise allows the function call to proceed if it is safe to do so.

The Customer Configuration Module 119 provides a graphical user interface allowing customer to identify functions of their application that the customer wants to have evaluated. As discussed above, the Interposition Code Generation Module 112 will generate customized interposition code for the identified functions.

The graphical user interface receives information about a customer application, such as the name of the application, the language of the application is written in, any particular functions that the customer wants to have monitored, and any particular web sites that the customer's application should or should not access. The information is stored on the database 120. Additionally, the Customer Configuration Module may generate a graphical user interface, electronic reports and/or electronic alerts (e.g., e-mails, text messages, etc.) identifying information about their application where a function was called and was deemed to be unsafe or secure. This information allows the customer to know if their application is being attacked by malicious code. Also, the type of function call may also be defined with a priority alert status. For example, a customer may want to immediately know when a web page is being attacked for the specified type of function call.

As used herein the communications network 115 may be an electronic network (e.g., any one of a local area network, wide area network, the Internet or an intranet) providing for the receiving and transmission of data among devices. In one embodiment, the communication networks 115 are TCP/IP based networks where data is transmitted using transport layer security (TLS) so that data transmissions are encrypted on the communications network 115. Additionally, the system 100 may use virtual private network for connections over the communications network 115 among servers, devices and/or services and applications.

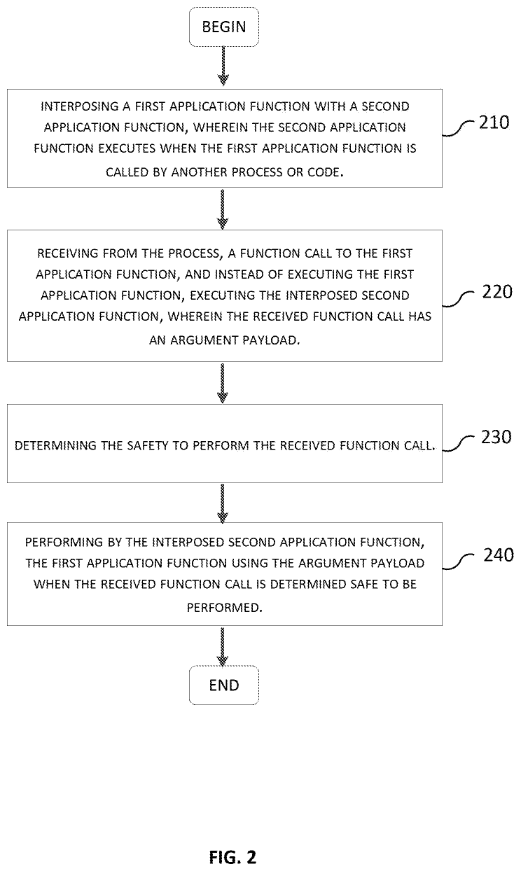

FIG. 2 illustrates a flowchart of an example process for interposed secure function calls. A standard application function is redefined to call another specific newly defined function that performs some security or safety checks or other actions before the standard application function is called. The checks are used to ensure security and safety of performing the standard application function.

The system 100 interposes a first application function with a second application function (block 210). The second application function is defined in such a way that when the first application function is called or executed by a process or other code, the second application function will be executed.

The system 100 receives from the process or other code, a function call to the first application function (block 220). Instead of executing the first application function (i.e., the application function that was actually called), the system 100 executes the interposed second application function (i.e., the redefined function). The first application function typically has an argument payload including one or more arguments, objects or other data used with the first application function.

The system 100 determines the safety or security to perform the received function call (block 230). The system 100 evaluates the argument payload and/or type of function to determine whether the received function call is suspect, may include malicious code and/or include an attempt to transfer sensitive data to a third-party server. Based on the determined safety or security, the system 100 may totally block the received function call from being performed, throw a warning, modify the received function call, or allow the function call to continue.

The system 100 performs by the interposed second application function, a new function call of the same type of the received function call if the system 100 determines that the received function call is determined safe or secure to be performed (block 240). If the system 100 allows the received function call to be performed, the argument payload from the received function call is used by the second application function when the system 100 executes the new function call.

The system 100 may determine whether it is safe or secure to perform the received function call in different ways. For example, in one embodiment the interposition code running in a web browser may determine whether the function call is safe or secure to be performed without the necessity to interact with the Security Service 110 to make the safety determination. In other words, the interposition code running in the web browser may include self-contained security and safety processing code for making the determination. In another embodiment, the interposition code interacts with the Security Service 110 and transmits event data and/or other information about a received function call to the Security Service 110. The Security Service 110 evaluates the received information from the interposition code. The Security Service 110 then may determine whether the received function call is safe to be performed. If the received function is determined safe to be performed, then the Security Service 110 may send an indication back to the web page that the received function call is safe to be performed.

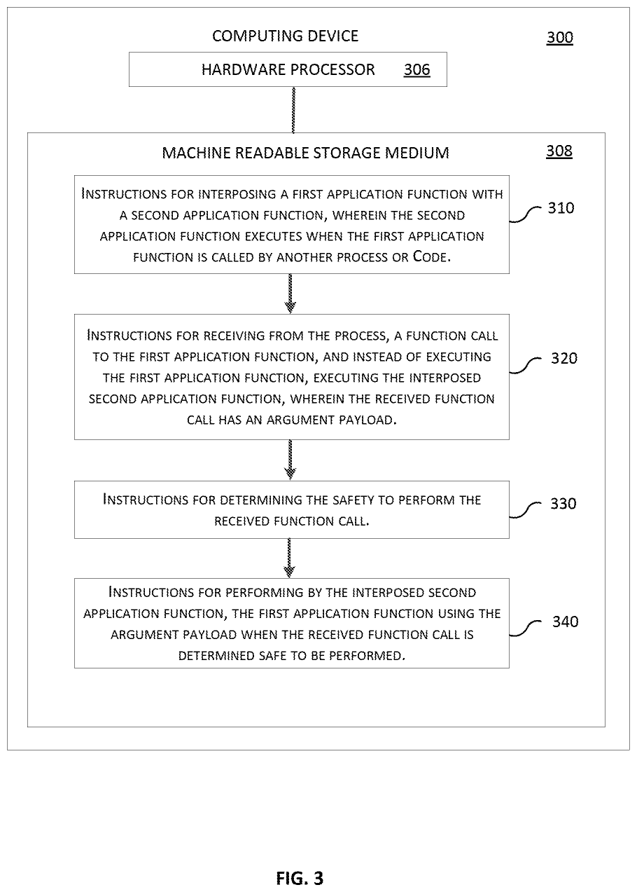

FIG. 3 illustrates a non-transitory computer media including instructions for interposed secure function calls. While not described in FIG. 3, the instructions are to be understood to include the more detailed processes as disclosed herein. A computing system 300 includes one or more hardware processors 306. On a non-transitory machine readable storage medium 308 instructions to perform interposed secure function calls are stored. In block 310, instructions are included for interposing a first application function with a second application function, where the second application function executes when the first application function is called by another process or other code. In block 320, instructions are included for receiving from the process or other code, a function call to the first application function, and instead of executing the first application function, executing the interposed second application function. The received function call typically has an argument payload. In block 330, instructions are included for determining the security or safety to perform the received function call. In block 340 instructions are included for performing by the interposed application function, the first application function using the argument payload when the received function call is determined to be safe or secure to be performed.

With reference to FIGS. 2 and 3, using interposed secure function calls allows the system 100 to redirect a received function call to the redefined function call. This prevents the original function call from being executed or performed. The redefined function call may then inspect or analyze the type of the original function call and/or the argument payload of the original function call. If the original function call is determined to be safe or secure to execute, then the system 100 may execute a new function call of the same type and with the same argument payload as the original function call.

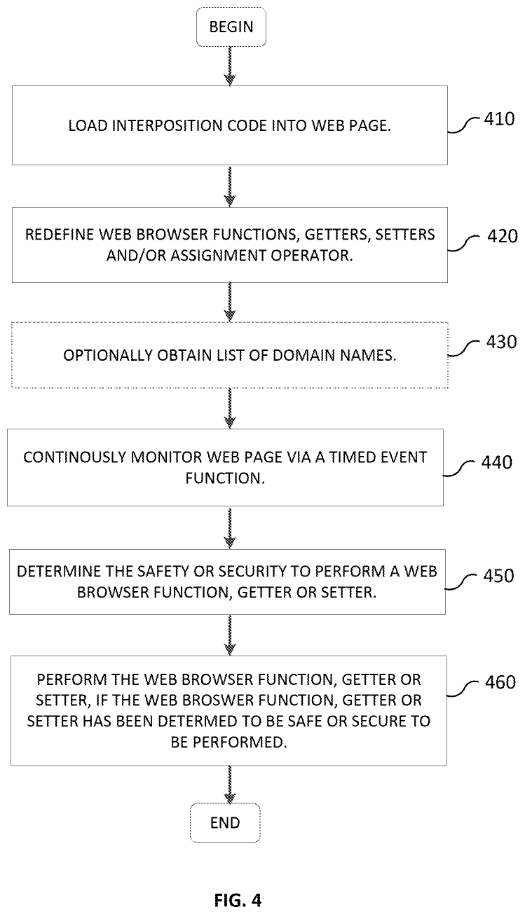

FIG. 4 illustrates a flowchart of an example process for interposed secure function calls for a web page and web browser. In this example, a web page and web browser may be configured to interpose standard web browser functions or methods with redefined functions or methods. The standard web browser functions or methods are to be understood to be the same as the first application function as described in reference to FIGS. 2 and 3.

When a web page is loaded, the web page loads interposition code (block 410). The interposition code may be wholly self-contained in the web page or may be partially retrieved code from the Security Service 110. For example, the initial interposition code may load additional code (e.g., core code which has more functionality, rules, security check logic than the initial interposition code) obtained from the Security Service 110 to redefine standard functions of the web browser and/or perform security checks on redefined functions.

The interposition code is in the form of JavaScript code loaded inline at the top of the HTML document. A website loads the JavaScript interposition code in the <head> tag of the web page. In an HTML document, the <head> tag begins the head section of the web page. The head section typically includes metadata about a web page and is not displayed in a web browser when the web page is loaded.

Loading the interposition code inline at the top of the HTML document becomes tamper resistant because the interposition code is the first JavaScript code loaded into the web page. Since the interposition code is the first JavaScript code loaded, the interposition code may redefine web browser functions, methods or objects before other malicious code could try to redefine them.

The interposition code may be retrieved from the Security Service 110 and loaded by the inline JavaScript in a secure tamperproof manner. Instead of loading the interposition code with a normal <script> tag, the interposition code may be loaded using an Asynchronous JavaScript And XML (AJAX) request. For example, the process to load the interposition code may be as follows:

Line 001: let f=new Function(code);

Line 002: f.call({tamperproofData: passedDataGoesHere});

With this AJAX request, the passed in data is not available or accessible to normal code running in a web browser. This allows secure retrieval of the interposition code from the Security Service 110.

Additionally, the interposition code may include sections allowing a user to customize code relevant to their particular application. For example, user custom code may be added to a function closure with relevant variables and functions being private to the closure. The customized code is made part of the interposition code, and as such, variables functions defined in the function closure are not directly accessible by third-party code or processes.

The interposition code may be customized by the Security Service 110 for the respective web page. For example, the Security Service 110 may receive an identifier for the web page and identify that the web page is related to a particular customer. The Security Service 110 may include in the database 120 a list of particular function calls that should be interposed (i.e., redefined) for a respective customer based on the identifier. The Security Service 110 then generates JavaScript interposition code to interpose the respective function calls that are germane or of concern to the customer and transmits the code web browser 150.

The interposition code interposes (i.e., redefines) standard JavaScript functions, getters, setters, assignment operators and/or core web browser objects and redefines them with new functionality (block 420). For example, by redefining the standard functions, every time normal JavaScript code does something interesting (e.g., making a network request, loading a new script, redirecting to a new page), the normal JavaScript code calls the redefined functions instead of the original functions, and the redefined function may analyze the originally called function and its argument payload to determine if malware or malicious activity is present. Common JavaScript functions and objects that may be interposed include: XMLHttpRequest, fetch, Image, HTMLImageElement, Script, HTMLScriptElement, Link, HTMLLinkElement, HTMLIFrameElement, HTMLFrameElement, HTMLAudioElement, HTMLVideoElement, Web Socket, document.cookie, HTMLFormElement, EventSource, innerHTML, setTimeout, setInterval, clearTimeout, clearInterval, navigator.serviceWorker, navigator.serviceWorker.getRegistrations, navigator.serviceWorker.register, or other functions as will be appreciated by a person skilled in the art.

In addition to redefining standard JavaScript functions, the interposition code may also interpose web browser object's getters and setters. Getters are used to access properties of an object. Getters are typically object functions where no arguments are passed via the function, but return some kind of value. Setters are used to change or modify an object.

Interposing JavaScript getters can be especially useful when looking for signs of malware. The system 100 may monitor all read access to objects and check for read access patterns that may be indicative of malware. For example, malware may scan a web browser's objects to detect what browser vulnerabilities are present. To detect scanning of multiple objects by the malware, the redefined getters may include a global counter and increment the global counter each time the getter is called. Malware invoking multiple object getters then would increment the global counter. If the global counter exceeds a threshold value, then the system 100 may determine that malware is likely trying to determine browser vulnerabilities. The system 100 them may take some action, such as reporting the potential malware threat to the Security Service 110 and/or stopping the web page from further JavaScript processing.

Additionally, the interposition code may override the assignment operator (“=”). For example, the assignment operator may be redefined such that the assignment operator does something different when applied to a Javascript object. The assignment operator is important to redefine because the assignment operator is a function that could perform network operations from some Javascript objects.

The interposition code may optionally obtain datasets identifying malware signals and potentially suspect domain names and Internet Protocol (IP) addresses (block 430). A list of malware signals and domain names and IP addresses may be included in the database 120, and the list of malware signals and domain names and IP addresses may be retrieved by the interposition code. In one embodiment, the interposition code may retrieve an initial comprehensive list of malware signals and domain names and IP addresses. This list may be cached on the client device 140 by the web browser 150. The interposition code then may check with the Security Service 110 if any updates exist to the initial data file. If updates are determined to exist, then the interposition code may retrieve a smaller data file with new or more time-sensitive malware signals. By first obtaining a large initial file, and then receiving smaller update files, the large file can be cached so that the web browser 150 does not need to re-download the large initial file regularly. Since the small file may change multiple times a day, the small file can be updated by the system 100 and retrieved by the interposition code on a more frequent basis.

Periodically, the system 100 may merge the initial data file with the smaller change file, so that a new comprehensive initial data file is created and may be retrieved by the interposition code. While the large initial file and smaller files may be generated by the Security Service 110, the files may also be hosted on and retrieved from a Content Delivery Network (CDN). While the datasets may be retrieved by the interposition code, a customer may also configure the inline JavaScript to include specific items relevant to the customer. For example, additional white-list (e.g., approved) or black-list (e.g., unapproved) websites, domain names or IP addresses may be included in the security policy, and enforced by the interposition code.

The interposition code will recognize these lists and during the security check will determine if a function call having a network request is being made to an approved or unapproved server. If the request is being made to a black-listed website and/or is not being made to an approved white-listed website then the system 100 would determine that the function call is not safe or secure to be performed. While the customer may configure the inline JavaScript, the whitelist and blacklist sites may also be stored in the database 120 and retrieved by the Security Service 110 and added to the interposition code.

The system 100 may continuously monitor a web page via a timed event function (block 440). The interposition code may include particular code for timing events, such as code to set a function timeout or function time interval. The interposition code may continuously monitor a web page by setting functions that run at intervals using the Javascript setTimeout or setInterval functions. Function interposition is used to rewrite the clearTimeout and clearInterval functions so that those functions cannot be used to turn off the timers that the system is using for monitoring.

In JavaScript, a setTimeout method or setInterval method may be used. The setTimeout (function, milliseconds) method executes a named function after waiting a particular number of milliseconds after the setTimeout method was called. The setInterval(function, milliseconds) repeatedly executes the named function every period of specified milliseconds. However, the setTimeout and setInterval methods may be cancelled with a clearTimeout or clearInterval methods respectively. Malicious JavaScript code could potentially stop the code for the timing events. To avoid this situation, the interposition code should include interposed (e.g. redefined) clearTimeout and clearInterval methods. Doing so, ensures that malicious JavaScript code will not be able to clear out callbacks originated from the interposition code. The timer may be used to regularly check the web page for changes that may indicate security vulnerabilities, or to regularly send data back to a server.

The system 100 may determine the safety or security to perform a web browser function, getter or setter (block 450). If the web browser function, getter or setter, is determined by the system 100 to be safe or secure to be performed, then the system 100 will perform the web browser function, getter or setter (block 460).

Each time an original function is called which has an interposed function, the interposed function performs the original function if the system 100 determines that it is safe to do so. Evaluating whether to perform the original function allows the interposed function call to protect against different types of threats or malware, such as data exfiltration in browsers (e.g. stealing passwords, credit card numbers, session cookies, or keylogging), loading new malicious scripts, redirecting to unexpected domains, controlling camera or voice usage, or anything else a browser can do that one would want to control.

The interposition code may log events and send them to the Security Service 110 individually as an individual call is being to the interposition code or in a batch process. In the batch process, the interposition code may keep track of calls being made to interposed functions, and the particular called interposed function may add an entry to an array or buffer indicating that that the respective interposed function has been called. Additionally, the argument payload may be added by the interposed function to the array or buffer. Then periodically based on a predetermined time interval (e.g., every 120 seconds), the events contained in the buffer or array may be transmitted to the Security Service 110 for further analysis or recording by the system 100 to the database 120. The batch process avoids frequent network request and transactions being made to the Security Service 110.

The system 100 may perform security and safety checks on the originally called functions and their argument payloads. The security checks can be hardcoded and enforced in the interposition code, can be based on predetermine deterministic rules enforced by the Security Service 110, can be implemented using machine learning models of the Security Service 110, or can based on a combination of the preceding security checks. The system 100 when using a machine learning model can train the machine learning model on ground truth data about which function calls were malicious and should have been stopped, versus which function calls were safe to be performed. The system 100 then can learn which function calls to stop based on the function characteristics. The system 100 may also be used to flag suspicious events for further investigation.

Predetermined deterministic rules also may be created, and the logic to enforce the rules may be stored in the database 120 or may be hardcoded into the interposition code. For example, simple rules may be enforced such as: do not allow network requests to particular domain names or IP addresses; never allow access to the device microphone or camera, etc. The rules may be configured via the user interface generated by the Customer Configuration Module 119. The interposed function may then determine whether an originally called function is violating a predetermined rule and take appropriate action. The following describes additional safety or security checks that may be performed by the system 100. These additional safety checks may be performed by the interposition code, by the Security Service 110, or a combination thereof.

The system 100 may determine the safety or security to perform a received function call by utilizing a list of banned website addresses. The list of banned websites identifies domain names or IP addresses that are not safe to access. The system compares at least a portion of the argument payload from the received function call to the list to determine whether the argument payload includes a website address identified on the list. The system 100 will prevent access to the website address when the argument payload has been determined to include a website address on the list.

The system 100 may determine the safety or security to perform a received function call by determining whether at least a portion of the argument payload includes sensitive data and whether the received function call includes a network request. The system 100 would determine the received function call is not safe to be performed based at least in part on determining that the argument payload includes sensitive data and the received function call includes a network request. For example, the system 100 may determine that the argument payload includes sensitive data such as a credit card number or password.

The system 100 may determine the safety or security to perform a received function call by transmitting at least a portion of the argument payload from the web browser to the Security Service 110. The Security Service 110 evaluates the argument payload for safety or security. The Security Service 110 then transmits to the web browser an indication of whether the argument payload is safe to be performed. If the indication received by the web browser indicates that the argument payload is not safe or is not secure to be performed, then the web browser will not perform the received function call.

The system 100 may determine the safety or security to perform a received function call by comparing at least a portion of the argument payload to a list of predetermined HTML tags. The system 100 may determine that the received function call is not safe or secure to be performed based at least in part on determining that the argument payload includes one or more of the predetermined HTML tags. For example, some suspect HTML tags include <embed> or <object> or <applet> or <iframe>.

The system 100 may determine the safety or security to perform a received function call by comparing the arguments with expected arguments based on third party APIs, then determining whether or not the function call is safe or secure to be performed. For example, a client may want to use a third-party analytics service like Google Analytics with only their own tracking id, but prevent Google Analytics from being used with any other tracking ids.

The system 100 may determine the safety or security to perform a received function call by using the size of the argument payload as an indicator. The system 100 may determine that the received function call is not safe or secure to be performed based on the size in conjunction with other factors.

The system 100 may determine the safety or security to perform a received function call by comparing the number of parameters of the argument payload to a threshold acceptable number of parameters for an argument payload. The system 100 may determine that the received function call is not safe or secure to be performed based at least in part on determining that the number of parameters of the argument payload exceeds the acceptable number of parameters for an argument payload.

The system 100 may determine the safety or security to perform a received function call by determining whether the argument payload is encrypted or compressed. The system 100 may determine that the received function call is not safe to be performed based at least in part on determining that the argument payload has been determined to be encrypted or compressed.

The system 100 may determine the safety or security to perform a received function call by comparing a type of the received function call to a list of predetermined types of function calls. The system 100 may determine that the received function call is not safe to be performed based at least in part on determining that the type of the received function call is included in the list of predetermined types of function calls. For example, the system 100 may use an approved list and/or unapproved list of specific function calls that may or may not be used by an application. The list of specific function calls may be stored in the database 120 and retrieved by the Security Service 110.

The system 100 may determine the safety or security to perform a received function call by evaluating whether the argument payload includes encoded polymorphic code that is able to decode itself so that the polymorphic code may be executed. The system 100 may determine the received function call is not safe or secure to be performed based at least in part on determining that the argument payload is determined to include polymorphic code.

The system 100 may determine the safety or security to perform a received function call by indicating a device (e.g. a camera or microphone) of the computer system as not to be used. Generally, most web sites will not use a microphone or camera of a device. The system 100 may determine whether the received function call would try to activate the device of the computer system that otherwise has been indicated as not to be used. The system 100 may determine that the received function call is not safe or secure to be performed based at least in part on determining that the received function call would try to activate the device that has been indicated as not to be used.

The system 100 may determine the safety or security to perform a received function call by determining if the received function may perform code in unusual ways (e.g., making a network request in unusual manner). The system 100 may determine the received function call is not safe or secure to be performed based at least in part on determining that the system 100 determines the function call would perform code in an unusual manner.

The system 100 may determine the safety or security to perform a received function call by determining whether the received function call includes suspicious decoding of code in the argument payload (e.g., often malware is polymorphic code which is received encoded, and decodes itself). The system 100 may determine the received function call is not safe or secure to be performed based at least in part on determining that the system 100 determines the function call includes decoding of code in the argument payload.

They system 100 may determine the safety or security to perform a received function call by determining if the received function call includes a network request to a domain name. The system 100 may obtain the registration information of the domain name. If the date of the registration less than a threshold period of time (e.g., less than 3 months old), then the system 100 may determine the received function call is not safe or secure to be performed. Other factors that may be evaluated by the system 100 include the registrar, the geolocation of the server, or by using lists of potential malicious IP address blocks.

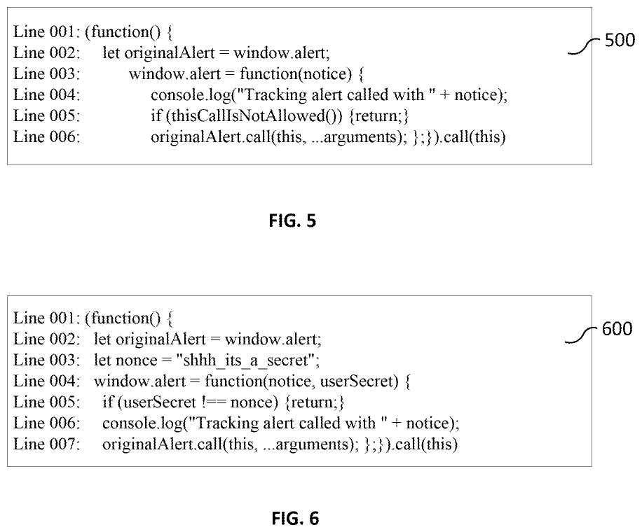

FIG. 5 illustrates example code 500 for interposing functions of an application. The brackets { } indicate grouping of logical units of code within the brackets. The example JavaScript code redefines originalAlert to window.alert. Any time the originalAlert function is called by other code or process, the window.alert function will be executed.

Line 001: (function( ) {

Line 002: let originalAlert=window.alert;

Line 003: window.alert=function(notice) {

Line 004: console.log(“Tracking alert called with”+notice);

Line 005: if (thisCallIsNotAllowed( )) {return;}

Line 006: originalAlert.call(this, . . . arguments);};}).call(this)

In the example code, the alert function is now made up of two components: (1) customized code shown in lines 004 and 005 as a simple console.log and thisCalllsNotAllowed( ) function), and (2) the original originalAlert function in line 006. While this is a simple example, an actual interposed function would be more complex. As shown in this example, there is no way to call the originalAlert without performing the customized custom code. The only reference to originalAlert is inside the function window.alert.

FIG. 6 illustrates example code 600 for interposing functions of an application. The brackets { } indicate grouping of logical units of code within the brackets. The example JavaScript code redefines originalAlert to window.alert. This example shows function execution based on permissions or capabilities of the underlying code. The alert code described in FIG. 3 may be revised as:

Line 001: (function( ) {

Line 002: let originalAlert=window.alert;

Line 003: let nonce=“shhh_its_a_secret”;

Line 004: window.alert=function(notice, userSecret) {

Line 005: if (userSecret !==nonce) {return;}

Line 006: console.log(“Tracking alert called with”+notice);

Line 007: originalAlert.call(this, . . . arguments);};}).call(this)

This example demonstrates that only code or processes with the right permissions may call the originalAlert function. Here there is no way for code outside the window.alert function to know the value of the variable nonce defined in line 003. Instead of an additional function parameter, the userSecret could also be a check to some global variable such as window.currentPermissionSecret. By checking against the global variable, the function call signatures would not be changed, so no specific function code change would be necessary.

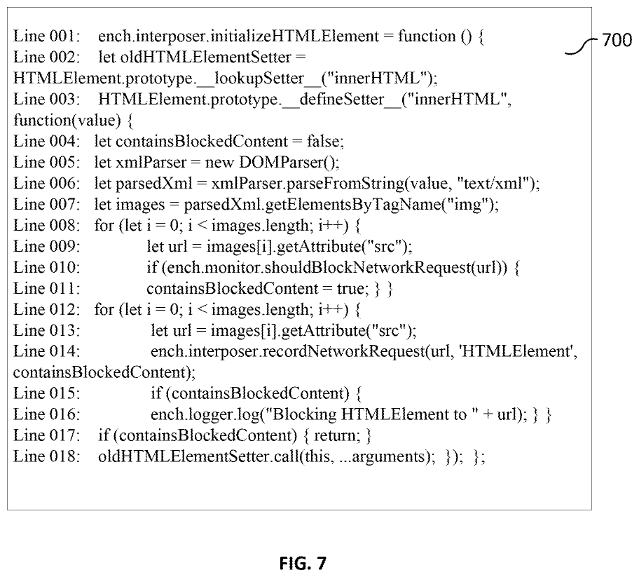

FIG. 7 illustrates example code 700 for interposing functions of an application. This shows by example how all images created with innerHTML=“html here” can be screened to block malicious source URLs.

Line 001: ench.interposer.initializeHTMLElement=function ( ) {

Line 002: let oldHTMLElementSetter=HTMLElement.prototype._lookupSetter_(“innerHTML”);

Line 003: HTMLElement.prototype._defineSetter_(“innerHTML”, function(value) {

Line 004: let containsBlockedContent=false;

Line 005: let xmlParser=new DOMParser( );

Line 006: let parsedXml=xmlParser.parseFromString(value, “text/xml”);

Line 007: let images=parsedXml.getElementsByTagName(“img”);

Line 008: for (let i=0; i<images.length; i++) {

Line 009: let url=images[i].getAttribute(“src”);

Line 010: if (ench.monitor.shouldBlockNetworkRequest(url)) {

Line 011: containsBlockedContent=true; }}

Line 012: for (let i=0; i<images.length; i++) {

Line 013: let url=images[i].getAttribute(“src”);

Line 014: ench.interposer.recordNetworkRequest(url, ‘HTMLElement’, containsBlockedContent);

Line 015: if (containsBlockedContent) {

Line 016: ench.logger.log(“Blocking HTMLElement to”+url); }}

Line 017: if (containsBlockedContent) {return;}

Line 018: oldHTMLElementSetter.call(this, . . . arguments);});};

The interposition may also use the Service Worker API to interpose all network requests, as the following service worker code illustrates:

Line 001: self.addEventListener(‘fetch’, function(event) {

Line 002: console.log(“Interposing”+event.request.url);

Line 003: if (ench.monitor.shouldBlockNetworkRequest(event.request.url)) {

Line 004: console.log(“Blocking”+event.request.url);

Line 005: var emptyPromise=new Promise(function( ) { });

Line 006: event.respondWith(emptyPromise);

Line 007:} else {

Line 008: event.respondWith(

Line 009: fetch(event.request).then(function(response) {

Line 010: return response;})); }});

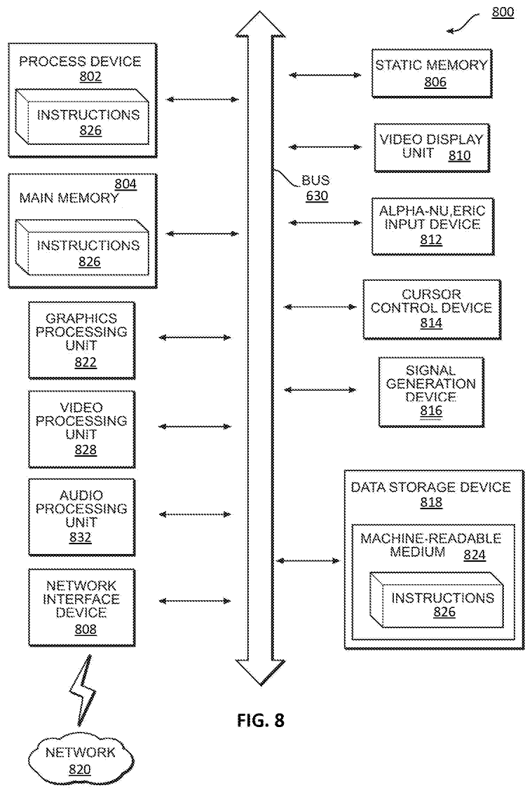

FIG. 8 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage device 818, which communicate with each other via a bus 830.

Processing device 802 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computer system 800 may further include a network interface device 608 to communicate over the network 820. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), a graphics processing unit 822, a signal generation device 816 (e.g., a speaker), video processing unit 828, and audio processing unit 832.

The data storage device 818 may include a machine-readable storage medium 824 (also known as a computer-readable medium) on which is stored one or more sets of instructions or software 826 embodying any one or more of the methodologies or functions described herein. The instructions 826 may also reside, completely or at least partially, within the main memory 804 and/or within the processing device 802 during execution thereof by the computer system 800, the main memory 804 and the processing device 802 also constituting machine-readable storage media.

In one implementation, the instructions 826 include instructions to implement functionality corresponding to the components of a device to perform the disclosure herein. While the machine-readable storage medium 824 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

In general, the terms “engine” and “module”, as used herein, refer to logic embodied in hardware or firmware, or to a collection of software instructions, possibly having entry and exit points, written in a programming language, such as, for example, JavaScript, Python, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on one or more computer readable media, such as compact discs, digital video discs, flash drives, or any other tangible media. Such software code may be stored, partially or fully, on a memory device of the executing computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A system comprising one or more processors, and a non-transitory computer-readable medium including one or more sequences of instructions that, when executed by the one or more processors, cause the system to perform operations comprising:
interposing a first application function with a second application function, wherein the second application function executes when the first application function is called by another process or other code;
receiving from the process or other code, a function call to the first application function, and instead of executing the first application function, executing the interposed second application function, wherein the received function call has an argument payload;
determining the safety to perform the received function call; and
performing by the interposed second application function, the first application function using the argument payload when the received function call is determined safe to be performed, or otherwise not performing the first application function.

2. The system of claim 1, wherein the determining the safety to perform the received function call comprises:
receiving a list of website addresses, wherein the list of websites identifies domain names or IP addresses that are not safe to access;
comparing at least a portion of the argument payload to the list to determine whether the payload includes a website address identified on the list; and
preventing access to the website address when the argument payload has been determined to include a website address on the list.

3. The system of claim 1, wherein determining the safety to perform the received function call comprises:
determining whether at least a portion of the argument payload includes sensitive data and whether the received function call includes a network request; and
determining the received function call is not safe to be performed based at least in part on determining that the argument payload includes sensitive data and the received function call includes a network request.

4. The system of claim 1, wherein determining the safety to perform the received function call comprises:
transmitting at least a portion of the argument payload to a remote server, wherein the remote server evaluates the safety of the argument payload;
receiving from the remote server an indication of whether the argument payload is safe; and
determining the received function call is not safe to be performed based at least in part on determining that the received indication is that the payload is unsafe.

5. The system of claim 1, wherein determining the safety to perform the received function call comprises:
comparing at least a portion of the argument payload to a list of predetermined HTML tags; and
determining the received function call is not safe to be performed based at least in part on determining that the argument payload includes one or more of the predetermined HTML tags.

6. The system of claim 1, wherein determining the safety to perform the received function call comprises:
comparing a size of the argument payload to a threshold acceptable argument payload size; and
determining the received function call is not safe to be performed based at least in part on determining that the size of the argument payload exceeds the threshold acceptable argument payload size.

7. The system of claim 1, wherein determining the safety to perform the received function call comprises:
determining whether the argument payload is encrypted or compressed; and
determining the received function call is not safe to be performed based at least in part on determining that the argument payload has been determined to be encrypted or compressed.

8. The system of claim 1, wherein determining the safety to perform the received function call comprises:
comparing a type of the received function call to a list of predetermined types of function calls; and
determining the received function call is not safe to be performed based at least in part on determining that the type of the received function call is included in the list of predetermined types of function calls.

9. The system of claim 1, wherein determining the safety to perform the received function call comprises:
evaluating whether the argument payload includes encoded polymorphic code that is able to decode itself so that the polymorphic code may be executed; and
determining the received function call is not safe to be performed based at least in part on determining that the argument payload includes polymorphic code.

10. The system of claim 1, wherein determining the safety to perform the received function call comprises:
indicating a device of the computer system as not to be used, wherein the device comprises a camera or microphone;
determining whether the received function call would try to activate the device of the computer system that has been indicated as not to be used; and
determining the received function call is not safe to be performed based at least in part on determining that the received function call would try to activate the device that has been indicated as not to be used.

11. The system of claim 1, wherein the application is a web browser, and JavaScript code to perform the interposing of the first application function is included in a <head> tag of a web page

12. The system of claim 1, wherein determining the safety to perform the received function call comprises:
determining a number of features of the received function call and/or of a web page performing the received function call, wherein the features include at least one or more of the argument payload, a domain name or IP address of a web site, a user's type of browser agent, sensitive data in the argument payload, whether there is polymorphic code present in the argument payload; and
determining whether the received function call is safe to be performed based on a function of the determined features.

13. The system of claim 1, further comprising the operation of:
loading interposition code in a secure tamperproof manner, wherein the interposition code interposes the first application function with the second application function.

14. The system of claim 1, further comprising the operation of:
removing from the original argument payload one or more suspicious arguments, data, code, and/or sensitive data to create a safe argument payload; and wherein performing by the interposed second application function, the first application function uses the safe argument payload instead of the original argument payload.

15. A method implemented by a system comprising one or more processors, the method comprising:
interposing a first application function with a second application function, wherein the second application function executes when the first application function is called by another process or other code;
receiving from the process or other code, a function call to the first application function, and instead of executing the first application function, executing the interposed second application function, wherein the received function call has an argument payload;
determining the safety to perform the received function call; and
performing by the interposed second application function, the first application function using the argument payload when the received function call is determined safe to be performed, or otherwise not performing the first application function.

16. The method of claim 15, wherein the determining the safety to perform the received function call comprises:
receiving a list of website addresses, wherein the list of websites identifies domain names or IP addresses that are not safe to access;
comparing at least a portion of the argument payload to the list to determine whether the payload includes a website address identified on the list; and
preventing access to the website address when the argument payload has been determined to include a web site address on the list.

17. The method of claim 15, wherein determining the safety to perform the received function call comprises:
determining whether at least a portion of the argument payload includes sensitive data and whether the received function call includes a network request; and
determining the received function call is not safe to be performed based at least in part on determining that the argument payload includes sensitive data and the received function call includes a network request.

18. The method of claim 15, wherein determining the safety to perform the received function call comprises:
transmitting at least a portion of the argument payload to a remote server, wherein the remote server evaluates the safety of the argument payload;
receiving from the remote server an indication of whether the argument payload is safe; and
determining the received function call is not safe to be performed based at least in part on determining that the received indication is that the payload is unsafe.

19. The method of claim 15, wherein determining the safety to perform the received function call comprises:
comparing at least a portion of the argument payload to a list of predetermined HTML tags; and
determining the received function call is not safe to be performed based at least in part on determining that the argument payload includes one or more of the predetermined HTML tags.

20. The method of claim 15, wherein determining the safety to perform the received function call comprises:
comparing a size of the argument payload to a threshold acceptable argument payload size; and
determining the received function call is not safe to be performed based at least in part on determining that the size of the argument payload exceeds the threshold acceptable argument payload size.

21. The method of claim 15, wherein determining the safety to perform the received function call comprises:
determining whether the argument payload is encrypted or compressed; and
determining the received function call is not safe to be performed based at least in part on determining that the argument payload has been determined to be encrypted or compressed.

22. The method of claim 15, wherein determining the safety to perform the received function call comprises:
comparing a type of the received function call to a list of predetermined types of function calls; and
determining the received function call is not safe to be performed based at least in part on determining that the type of the received function call is included in the list of predetermined types of function calls.

23. The method of claim 15, wherein determining the safety to perform the received function call comprises:
evaluating whether the argument payload includes encoded polymorphic code that is able to decode itself so that the polymorphic code may be executed; and
determining the received function call is not safe to be performed based at least in part on determining that the argument payload includes polymorphic code.

24. The method of claim 15, wherein determining the safety to perform the received function call comprises:
indicating a device of the computer system as not to be used, wherein the device comprises a camera or microphone;
determining whether the received function call would try to activate the device of the computer system that has been indicated as not to be used; and
determining the received function call is not safe to be performed based at least in part on determining that the received function call would try to activate the device that has been indicated as not to be used.

25. The method of claim 15, wherein the application is a web browser, and JavaScript code to perform the interposing of the first application function is included in a <head> tag of a web page.

26. The method of claim 15, wherein determining the safety to perform the received function call comprises:
determining a number of features of the received function call and/or of a web page, wherein the features include at least one or more of the argument payload, a domain name or IP address of a website, a user's type of browser agent, sensitive data in the argument payload, whether there is polymorphic code present in the argument payload; and
determining whether the received function call is safe to be performed based on a function of the determined features.

27. The method of claim 15, further comprising the operation of:
loading interposition code in a secure tamperproof manner, wherein the interposition code interposes the first application function with the second application function.

28. The method of claim 15, further comprising the operation of:
removing from the original argument payload one or more suspicious arguments, data, code, and/or sensitive data to create a safe argument payload; and wherein performing by the interposed second application function, the first application function uses the safe argument payload instead of the original argument payload.

29. A system comprising one or more processors, and a non-transitory computer-readable medium including one or more sequences of instructions that, when executed by the one or more processors, cause the system to perform operations comprising:
interposing a first application function with a second application function, wherein the second application function executes when the first application function is called by another process or other code;
receiving from the process or other code, a function call to the first application function, and instead of executing the first application function, executing the interposed second application function, wherein the received function call has an argument payload; and
tracking an event of the received function call by transmitting, by the interposed second application function data, to a server about the received function call, wherein the data includes one or more of the following information: the date/time of the function call, the argument payload, name of the process or other code making the function call, the number of arguments of the received function call, the size of the argument payload, a customer identifier, or a web page identifier.
